(19) United States
(12) Patent Application Publication
(10) Pub. No.: US 2023/0184220 A1
(43) Pub. Date: Jun. 15, 2023

(54) WIND TURBINE BLADE LIFTING DEVICE

(71) Applicant: Barnhart Crane and Rigging Co., Memphis, TN (US)

(72) Inventors: Kevin Reynolds, Memphis, TN (US); William Shaw, Memphis, TN (US)

(21) Appl. No.: 17/923,851

(22) PCT Filed: May 5, 2021
(86) PCT No.: PCT/US2021/030910

§ 371 Date: Nov. 7, 2022

Related U.S. Application Data
(60) Provisional application No. 63/020,220, filed on May 5, 2020.

(51) Int. Cl. F03D 13/40; B66C 1/10; B66C 1/66

(52) U.S. Cl. CPC F03D 13/40; B66C 1/108; B66C 1/66; F05B 2230/61

(57) ABSTRACT

A wind turbine blade lifting device is provided, comprising a backing member adapted to contact an interior surface of a wind turbine blade; a connector rod having an upper end and a lower end, wherein the lower end is rotatably connected to the backing member; a cover plate connected to the connector rod, wherein the cover plate includes an alignment member; a primary lifting shackle rotatably connected to a base member engaged with the connector rod; and a securing nut threadably connected to the upper end of the connector rod. One or more spacers are positioned around the connector rod between the cover plate and an exterior blade surface. The device preferably includes a holding tool connectable to the upper end of the connector rod. The cover plate preferably includes one of more secondary shackles to enable engagement with other rigging equipment.

### CROSS-REFERENCE TO RELATED APPLICATIONS

The present application claims priority to U.S. Provisional Patent Application No. 63/020,220, filed May 5, 2020, which is incorporated herein by reference in its entirety.

### BACKGROUND OF THE INVENTION

### Field of the Invention

This invention relates to devices and methods used for removing damaged or worn blades from a wind turbine.

### Description of the Background

Over time and due to weather and other hazards, the blades of wind turbines can become damaged and must be removed and replaced. Due to the size of the blades and the equipment required to handle such large objects, it is essential to establish a secure connection to the damaged blade as it is disconnected from the pitch bearing and lowered to the ground. Slings and similar rigging equipment can sometimes slip, and there is a need to provide a blade lifting device that can be safely installed and connected to the damaged blade.

### SUMMARY OF THE INVENTION

A wind turbine blade lifting device is provided, comprising a backing member adapted to contact an interior surface of a wind turbine blade; a connector rod having an upper end and a lower end, wherein the lower end is rotatably connected to the backing member; a cover plate connected to the connector rod, wherein the cover plate includes an alignment member; a primary lifting shackle rotatably connected to a base member engaged with the connector rod; and a securing nut threadably connected to the upper end of the connector rod.

In a more preferred embodiment, one or more spacers are positioned around the connector rod between the cover plate and an exterior blade surface.

In another embodiment, the device further includes a holding tool connectable to the upper end of the connector rod.

In a further embodiment, the cover plate further includes one of more secondary shackles to enable engagement with other rigging equipment.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 illustrates a perspective exploded view of a preferred embodiment of the invention.

FIG. 2 illustrates an assembled view the embodiment of FIG. 1 along the longitudinal axis of the wind turbine blade.

FIG. 3 illustrates an assembled view the embodiment of FIG. 1 along the longitudinal axis of the wind turbine blade.

FIG. 4 illustrates an assembled sectional view of the embodiment of FIG. 1.

FIG. 5 illustrates an exterior view of the embodiment of FIG. 1 assembled to the wind turbine blade.

FIG. 6 illustrates a top perspective view of the backing member according to a preferred embodiment of the invention.

FIG. 7 is an isolated view of a connector portion designed to connect the connector rod to the backing member in a preferred embodiment of the present invention.

### DETAILED DESCRIPTION OF THE PREFERRED EMBODIMENTS

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

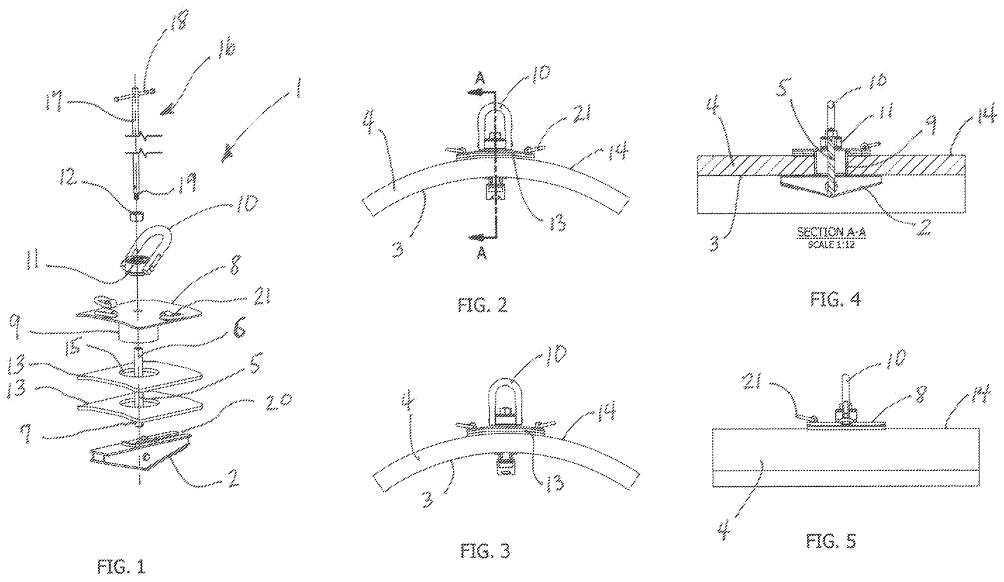

Referring now to the figures, and particularly with reference to FIG. 1, a preferred embodiment of a wind turbine blade lifting device 1 is shown in an exploded perspective view. The blade lifting device 1 generally comprises a backing member 2 adapted to contact an interior surface 3 of a wind turbine blade 4; a connector rod 5 having an upper end 6 and a lower end 7, wherein the lower end 7 is rotatably connected to the backing member 2; a cover plate 8 connected to the connector rod 5, wherein the cover plate 8 includes an alignment member 9; a primary lifting shackle 10 rotatably connected to a base member 11 which is engaged with the connector rod 5; and a securing nut 12 threadably connected to the upper end 6 of the connector rod 5.

FIG. 1 shows one preferred embodiment of the configuration of backing member 2. As can be seen, backing member 2 has a generally pentagonal cross-sectional shape. The top face of the backing member 2, which abuts the interior surface of the blade 3, is rectangular, with a slot (as will be described) formed in roughly half of the backing member 2 along its long dimension. The side of backing member 2 opposing its top face has a shallow point, which point is centered along the long side of the bottom of backing member 2 to accommodate the end of connector rod 5 when installed as shown in FIG. 4. On either side of the point the back side of backing member 2 is gradually tapered down to a flat side surface on either side of the backing member 2. In preferred embodiments, the angle between interior surfaces of each side of the back side of backing member 2 is 150 degrees. This unique configuration provides easy installation for the shackle. As will be described, a method of installing the shackle includes inserting backing member 2 through a drilled (or other) hole in the blade leading with its short end. Once the backing member 2 is inserted, it must pivot roughly 90 degrees so that its top surface rests against the interior surface 3 of the blade 4. Because both sides of the backing member 2 are tapered, backing member 2 has more clearance to rotate upon insertion, such that the trailing edge of the backing member 2 doesn't have to completely clear the opening before rotation begins. This means that connector rod 5 doesn't have to extend as far down into the interior of the blade 4 as it may with another design of backing member, lowering the overall height requirement for connector rod 5 and lowering the chance that backing member 2 may be dropped into the interior of the blade during installation.

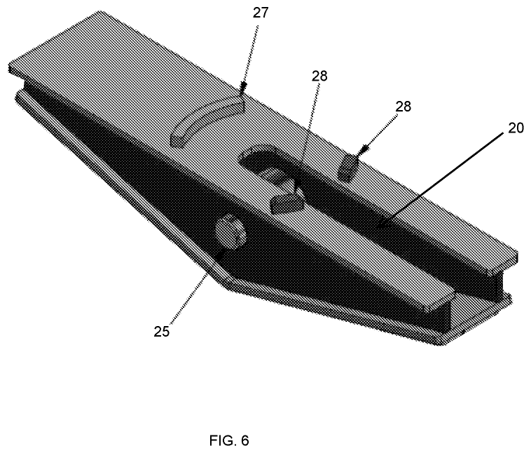

With specific reference to FIG. 6, the backing member further includes a slot 20 on its top face sufficient in width to allow the connector rod 5 to move therewithin, which allows greater rotational movement of the backing member 2 around the connector rod 5. In particular, slot 20 is sized to have an opening slightly larger than the cross section of the connector rod 5 (taken along its primary axis). Connector rod 5 is capable of tilting from a position perpendicular to backing member 2 (as shown in FIG. 1) to a position parallel with backing member 2 and thereby fitting within slot 20. This allows connector rod 5 and backing member 2 to essentially fold together into an element having the cross-sectional size of the backing member 2 alone, to allow backing member 2 to fit through a hole drilled into blade 4.

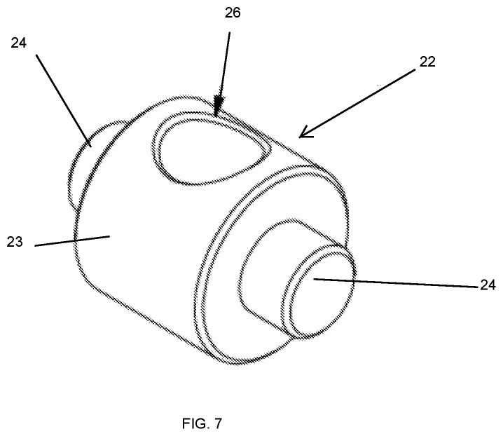

The connection between connector rod 5 and backing member 2 is shown in FIGS. 6 and 7. As shown, connector portion 22 is a device akin to a tee nut. It has a main body portion 23 which is cylindrical, and protrusions 24 on either end thereof which are sized to be rotatably accommodated in openings 25 in the sides of backing member 2. Connector portion 22 is thus rotatable around its primary axis within openings 25 in backing member 2, which, as will be seen, allows connector rod 5 to tilt from a perpendicular position relative to the surface of backing member 2 into a substantially parallel position relative to backing member 2, and to thereby seat within slot 20 for installation of backing member 2. On the circumferential surface of connector portion 22 is an opening 26 to accommodate the lower end 7 of connector rod 5. Opening 26 may itself be threaded to secure to the lower end 7 of connector rod 5. In alternative embodiments, opening 26 may accommodate a separate connection means (in the form of a tee nut or the like) which attaches directly to the lower end 7 of connector rod 5 and is rotatable relative to connector portion 22 around the primary axis of connector rod 5. In preferred embodiments, connector rod is therefore rotatable around its primary axis and tiltable relative to the top surface of backing member 2 while secured to backing member 2.

Backing member 2 is further sized to have at least one dimension which is as narrow as, or narrower than, the diameter of alignment member 9 in cover plate 8, which in FIG. 1 is shown to have a cylindrical shape extending down from cover plate 8, corresponding to the dimensions of a hole that will be drilled in blade 4 for insertion of the toggle 1 as described herein. Alignment member 9 is preferably a cylindrical-shaped member extending down from the bottom surface of cover plate 8, but other shapes of alignment member 9 can be envisioned, and backing member 2 can have a corresponding cross sectional shape (when a cross section is taken across its longest dimension) such that a hole that will accommodate alignment member 9 can also allow backing member 2 to pass therethrough for insertion into the interior of blade 4.

As shown in FIG. 6, backing member 2 may also optionally include “feet” 27, 28 to provide visual or tactile alignment markers between backing member 2 and alignment member 9.

Primary lifting shackle 10 can be in the form of a swivel hoist ring which is rotatable 360 degrees around its primary axis and tiltable 180 degrees to lay flat against the top of cover plate 8.

Once installed, the device 1 provides a secure connection to the blade 4 and which can be engaged by rigging hooks to lower the blade 4 to the ground. FIG. 4 illustrates a sectional view of the device 1 securely attached to the blade 4 and showing the manner in which the backing member 2 is tightened against the interior surface 3 when the securing nut 12 is installed to complete the assembly.

Depending on the thickness of the blade material, one or more spacers 13 can be positioned and stacked around the connector rod 5 between the cover plate 8 and an exterior blade surface 14. For example, if the blade thickness is relatively thin, the upper end 6 of the connector rod 5 may protrude too far into the primary lifting shackle 10 and interfere with a rigging hook. Addition of one or more spacers 13 will raise the height of the cover plate 8 enough to still expose the thread upper end 6 of the connector rod 5 for installation of the securing nut 12, but will also allow sufficient room for a rigging hook to engage with the primary lifting shackle 10. Also, as shown in FIG. 4, the spacers 13 may be required to lift the bottom edge of the alignment member 9 enough to allow the backing member 2 to seat positively against the interior surface 3 of the blade 4. In a preferred embodiment, each spacer 13 may include a hole 15 that engages with the alignment member 9 of the cover plate 8 so that the spacers 13 are properly aligned with one another and with the cover plate 8. It can thus be seen that the inventive device 1 can be adapted to provide a secure attachment to virtually any type of wind turbine blade, regardless of surface configuration or thickness. In preferred embodiments, spacers are formed from aluminum; in other embodiments, spacers can be made of steel or any other material which is strong enough to withstand the pressure of the blade during a lifting or lowering operation.

The cover plate 8 optionally may include one or more secondary shackles 21 which enable connection to additional rigging equipment during the blade removal and lowering operation.

To facilitate installation of the device 1, a holding tool 16 is useful to prevent loss of the backing member 2 inside the blade 4. The holding tool 16 includes an elongated member 17, an upper handle 18 at one end of the member 17, and an externally threaded end 19 at the opposite end of the member 17. The threaded end 19 matably engages with an internally threaded upper end 6 of the connector rod 5, such that the holding tool 16 facilitates installation of the device 1 and prevents the backing member 2 from falling inside the blade 4 and becoming unrecoverable.

To install the device 1, a hole is first formed into the blade 4 that is large enough to permit insertion of the backing member 2. The holding tool 16 is threadably attached to the upper end 6 of the connector rod 5, and the backing member 2 is inserted into the hole and then oriented as shown in FIG. 4. As described above, connector rod 5 is rotatable relative to backing member 2, so installation can comprise “folding” connector rod 5 down against the surface of backing member 2 and/or to a position seated within slot 20 in backing member 2. Optionally, the connection between connector rod 5 and backing member 2 can be spring loaded, biased towards a perpendicular orientation between connector rod 5 and backing member 2 as shown in FIG. 1. Thus, connector rod 5 can be folded down against backing member 2 and/or into slot 20, and pushed through the hole in the blade 4, and once backing member 2 clears the opposite end of the hole and is fully within the interior of the blade 4, it springs open to rest its top surface (the surface to which connector rod 5 is rotatably engaged) against the interior surface of the blade 4.

In various other embodiments of the invention, the device could be installed within an existing hole in the blade, such as the holes used for connecting the blade studs to the blade, and the inventive device could be sized to be accommodated in such an opening.

If spacers 13 are employed, then the spacers 13 are added, and then the cover plate 8 is positioned above the spacers 13 so that the alignment member 9 fits within the blade hole. Next, the base member 11 of the primary lifting shackle 11 is installed onto the connector rod 5, and the securing nut 12 is finally installed onto the upper end 6 of the connector rod 5 to tightly secure all of the parts of the device 1 onto the blade 4.

In some embodiments, the invention is a method of providing a secure attachment to a wind turbine blade during a raising, lowering, or transporting operation or other maneuver. According to this embodiment, the device 1 is installed on the blade 4 in question in the manner described above. The primary lifting shackle thereafter serves as an attachment point for various types of rigging which will be used to secure the blade to a crane or other lifting device for a given maneuver.

In other embodiments, the invention is a method for repairing and/or stabilizing a wind turbine blade by pulling two portions of the blade together. For example, a crack, hole or other weakness in the blade may pose a hazard to the crew attempting to move the blade, a risk of debris falling off of the blade and landing on the ground, or the like. In such circumstances, the inventive method can comprise installing two (or more) toggles 1 on opposite sides of the “crack” or other compromised portion of the blade, each in the manner described above. The toggles can then be secured together with a cable, com-a-long, or similar device to essentially “stich up” the crack temporarily before a full repair can be made, or to stabilize it for removal and/or transport. In this embodiment, the inventive method capitalizes on the fact that the inventive toggle can be installed at any location along the blade 4 and can be pulled in any direction by virtue of the configuration of backing member 2 (to provide even counter pressure against the interior surface of the blade) and the rotatability of the primary lifting shackle 10 both around and away from its primary axis.

The description and illustrations are by way of example only. While the description above makes reference to various embodiments, it should be understood that many changes and modifications can be made without departing from the scope of the disclosure. Many more embodiments and implementations are possible within the scope of this invention and will be apparent to those of ordinary skill in the art. The invention is not limited to the specific details, representative embodiments, and illustrated examples in this description.

### STATEMENT OF INDUSTRIAL APPLICABILITY

Wind turbines are now prevalent in the United States and abroad as a means of providing green energy to communities. Wind turbines generally comprise large blades which need to be raised or lowered between the ground and a tall tower which is installed independently of the (typically) three blades, which in operation turn around a central hub. The inventive device provides a means for secure connection to a blade in the case of such a raising or lowering operation. In alternative embodiments, the inventive device provides a means for repairing a wind turbine blade without removing it from the tower, or securing/stabilizing it for secure transport. The device is therefore useful to entities who install and/or repair such equipment.

We claim:

1. A wind turbine blade lifting device, comprising:
a backing member adapted to contact an interior surface of a wind turbine blade;
a connector rod having an upper end and a lower end, wherein the lower end is rotatably connected to the backing member;
a cover plate connected to the connector rod, wherein the cover plate includes an alignment member;
a primary lifting shackle rotatably connected to a base member engaged with the connector rod; and
a securing nut threadably connected to the upper end of the connector rod.

2. The device of claim 1, further comprising one or more spacers positioned around the connector rod between the cover plate and an exterior blade surface.

3. The device of claim 1, further including a holding tool connectable to the upper end of the connector rod.

4. The device of claim 1, wherein the cover plate further includes one of more secondary shackles.

5. The device of claim 1, wherein
the connector rod is rotatable relative to a top surface of said backing member; and
wherein said top surface of said backing member further includes a slot sized to accommodate the connector rod in a perpendicular position thereto.

6. The device of claim 1, wherein said backing member has a pentagonal cross-sectional shape.

7. A method for providing a secure connection to a wind turbine blade, the method comprising:
providing an opening in a wind turbine blade;
providing a wind turbine blade lifting device, comprising:
a backing member adapted to contact an interior surface of a wind turbine blade;
a connector rod having an upper end and a lower end, wherein the lower end is rotatably connected to the backing member;
inserting said wind turbine blade lifting device through said opening, wherein said backing member and said connector rod are parallel during said inserting step;
applying a cover plate to an exterior surface of said wind turbine blade, wherein the cover plate includes an alignment member;
connecting said cover plate to the connector rod;
connecting a base member to the connector rod, said base member being rotatably connected to a primary lifting shackle; and
securing a nut to the upper end of the connector rod.

8. The method of claim 7, wherein the method further comprises, prior to said step of inserting, providing a holding tool matably engaged with said upper end of the connector rod.

9. The method of claim 7, wherein the method further comprises, after said inserting step and before said applying step, rotating said backing member to a perpendicular position relative to said connector rod.

10. A method for repairing a damaged wind turbine blade, the method comprising:
providing one or more openings in a wind turbine blade;
providing at least two wind turbine blade lifting devices, each comprising:
a backing member adapted to contact an interior surface of a wind turbine blade;
a connector rod having an upper end and a lower end, wherein the lower end is rotatably connected to the backing member;
inserting each of said wind turbine blade lifting devices through one of said one or more openings, wherein said backing member and said connector rod are parallel during said inserting step;
applying a cover plate to an exterior surface of said wind turbine blade at each opening, wherein the cover plate includes an alignment member;
connecting each of said cover plates to a respective one of said connector rods;
connecting a base member to each of said connector rods, each said base member being rotatably connected to a primary lifting shackle;
securing a nut to the upper end of each of said connector rods.

11. The method of claim 10, further comprising linking each of said primary lifting shackles by a com-a-long or like device.

12. The method of claim 10, wherein:
each of said cover plates further comprises one or more secondary shackles; and
wherein said method further comprises linking each of said one or more blade lifting devices by a com-a-long or like device attached to said one or more secondary shackles.
